(19) United States
(12) Patent Application Publication
(10) Pub. No.: US 2019/0303564 A1
(43) Pub. Date: Oct. 3, 2019

(54) AUTOMATED CODE HIGHLIGHTING TO IDENTIFY RISK IN SOFTWARE PROGRAMMING

(71) Applicant: CA, Inc., Islandia, NY (US)

(72) Inventor: Ian Aloysious Kelly, Colleyville, TX (US)

(73) Assignee: CA, Inc., Islandia, NY (US)

(21) Appl. No.: 15/941,164

(22) Filed: Mar. 30, 2018

(51) Int. Cl. G06F 21/54; G06F 8/73; G06F 21/55; G06F 3/0481

(52) U.S. Cl. CPC G06F 21/54; G06F 3/04812; G06F 21/55; G06F 8/73

(57) ABSTRACT

A cursor is detected within a line of code presented in a source code editor window of a graphical user interface (GUI) of an integrated development environment (IDE), and a particular segment of code within a software program is determined to correspond to the line of code. A level of risk associated with the particular segment of code is determined from data comprising a repository of code changes relating to the particular segment of code, where the level of risk indicates a likelihood that changes to source code of the software program relating to the particular segment of code will jeopardize successful operation of the software program. At least a portion of the line of code is automatically highlighted within the source code editor window based on the level of risk and responsive to the placement of the cursor within the line of code.

### BACKGROUND

The present disclosure relates in general to the field of computer development, and more specifically, to integrated development environments capable of dynamically assessing risk through analysis of software development coding.

Modern software systems often include multiple programs or applications working together to accomplish a task or deliver a result. For instance, a first program can provide a front end with graphical user interfaces with which a user is to interact. The first program can consume services of a second program, including resources of one or more databases, or other programs or data structures. Software programs may be written in any one of a variety of programming languages, with programs consisting of software components written in source code according to one or more of these languages. Development environments exist for producing, managing and compiling these programs. For instance, an integrated development environment, or “IDE, may be used which includes a set of integrated programming tools such as code editors, compilers, linkers, and debuggers.

### BRIEF SUMMARY

According to one aspect of the present disclosure, a cursor is detected within a line of code presented in a source code editor window of a graphical user interface (GUI) of an integrated development environment (IDE), and a particular segment of code within a software program may be determined to correspond to the line of code. A level of risk associated with the particular segment of code may be determined from data comprising a repository of code changes relating to the particular segment of code, where the level of risk indicates a likelihood that changes to source code of the software program relating to the particular segment of code will jeopardize successful operation of the software program. At least a portion of the line of code may be automatically highlighted within the source code editor window based on the level of risk and responsive to the placement of the cursor within the line of code.

### BRIEF DESCRIPTION OF THE DRAWINGS

FIG. 1 is a simplified schematic diagram of an example computing system including an example development system in accordance with at least one embodiment;

FIG. 2 is a simplified block diagram of an example computing system including an enhanced integrated development environment in accordance with at least one embodiment;

FIG. 3 is a simplified block diagram illustrating data and flows involving an example repository system in accordance with at least one embodiment;

FIGS. 4A-4C are simplified block diagrams illustrating enhancing source code editor graphical user interfaces with risk highlighting to indicate the potential risk involved in editing particular lines of code using the source code editor in accordance at least some embodiments;

FIGS. 5A-5B are simplified block diagrams illustrating enhancing source code editor graphical user interfaces with risk highlighting to indicate the potential risk involved in editing particular lines of code relating to dependencies of a source code project in accordance at least some embodiments;

FIG. 6 is a simplified block illustrating enhancing source code editor graphical user interfaces with risk highlighting to indicate a risk to performance targets of a project posed by a change to source code in accordance with at least one embodiment;

FIGS. 7A-7D are simplified flowcharts illustrating example techniques associated with providing risk highlighting within a source code editor of a software development program in accordance with at least some embodiments.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

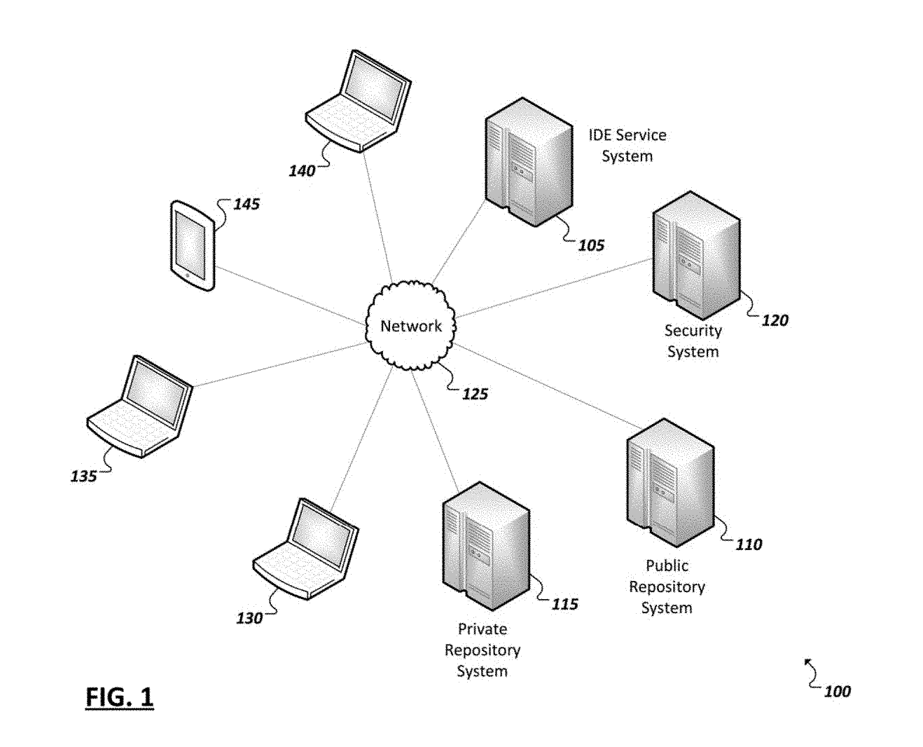

Referring now to FIG. 1, a simplified block diagram is shown illustrating an example computing environment 100 including an integrated development environment system 105, which may host an integrated development environment possessing enhanced functionality to dynamically identify risk within coding projects developed by user-developers using the integrated development environment (IDE). More particularly, in some implementations, the enhanced IDE may detect attempts to edit code corresponding to a particular software component and may determine that editing the code may present various risks. To warn the user of these underlying (and likely unseen) risks and provide guidance to the user as they attempt to engineer a code-based solution within a project.

In some implementations, an example system 100 may further include repository systems (e.g., 110, 115), such as a software configuration management (SCM) repository system. Repository systems may include repositories which are public, such that the repositories provide open source or shared software components together with management of changes within these components. An example repository system (e.g., 115) may also host and manage private repositories, such as an enterprise repository system or repository for a particular software development firm (e.g., to balance the privacy of the code being developed by such an enterprise (which may be of extreme importance) with developer collaboration within the enterprise through the repository system). In some implementations, an enhance IDE (e.g., as hosted by IDE system 105) may interface with and make use of records maintained by a repository system (e.g., 110, 115) to determine risk levels associated with pieces of code, which may be maintained and provided for re-use in other projects through the repository system. In some instances, the IDE system may be combined with a repository system such that the enhanced IDE may be used through an example repository system (e.g., 110, 115), among other example implementations.

Risk associated with a piece of code may be based on coding (or operability) risk and security risk. Operability risk may concern the probability that changes to a given piece of code may result in the piece of code not operating correctly (e.g., in connection with the remaining system (e.g., other components upstream or downstream from the component, a browser or other container (e.g., virtual machine, microservice container, etc.) in which the component is to run or through which its user interface or front-end is to operate, among other examples. Security risk may relate to the cyber security risks that may be presented by adding, deleting, or modifying a piece of code in a system. In some cases, security risk may be governed by security policies, which detail standards and safeguards that are to be maintained, at a global level (e.g., as a generally accepted standard or best practice) or on a system-specific level (e.g., dictating security policies that are tailored to a particular type of system, industry, corporation, etc.). A security system (e.g., 120) may be provided to maintain security policies for one or more systems and may further provide security event discovery and remediation services (e.g., security tools, counter measures, etc.), among other functionality. In some cases, data and services maintained and provided through an example security system (e.g., 120) may be used to identify source code components and changes to underlying source code that present a measure of security risk. Risk determined for a piece of code may be based on one or both of operability risk and security risk, such that developers using the enhanced IDE are made aware of issues they may have otherwise been unknown to them or that may have escaped the focus of the developer as they focus their attention on the development of a piece of code.

An example IDE system 105 may connect to and interface with other systems over one or more networks (e.g., 125), including repository systems (e.g., 110, 115) and security systems (e.g., 120) to determine code-based risk and enhance a graphical user interface (GUI) of the IDE to warn of this risk during coding. In some cases, the IDE system 105 may provide the enhanced IDE as a service (e.g., a cloud-based application), allowing remote client devices (e.g., 130, 135, 140, 145) to access the IDE through a web browser or other interface and generate new coding projects through the IDE. Various client devices (e.g., 130, 135, 140, 145) may also interface with repository systems (e.g., 110, 115) to provide various source code components (e.g., projects, applications, branches, etc.) for inclusion or updates to repositories hosted by the repository systems, among other examples.

In general, “servers,” “clients,” “computing devices,” “network elements,” “database systems,” “user devices,” and “systems,” etc. (e.g., 105, 110, 115, 120, 130, 135, 140, 145, etc.) in example computing environment 100, can include electronic computing devices operable to receive, transmit, process, store, or manage data and information associated with the computing environment 100. As used in this document, the term “data processing apparatus,” “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 120, 130, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, an IDE system 105, repository systems (e.g., 110, 115), security system 120, or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Modern software development may involve the cooperation of a team of developers working on respective portions of a larger software system. Further, it is becoming increasingly common for developers to rely on code components found in shared code libraries and include these components within their own projects and applications to provide objects, methods, functions, etc. for use in their projects without having to develop analogous components with similar functionality. Given these and other example trends, it is becoming increasingly difficult for individual developers and even teams of developers to understand the complex interconnections and underlying code within their own projects. As a result, developers may at times underappreciate the potential consequences and risks associated with edits and modifications they feel motivated to make, among other example issues.

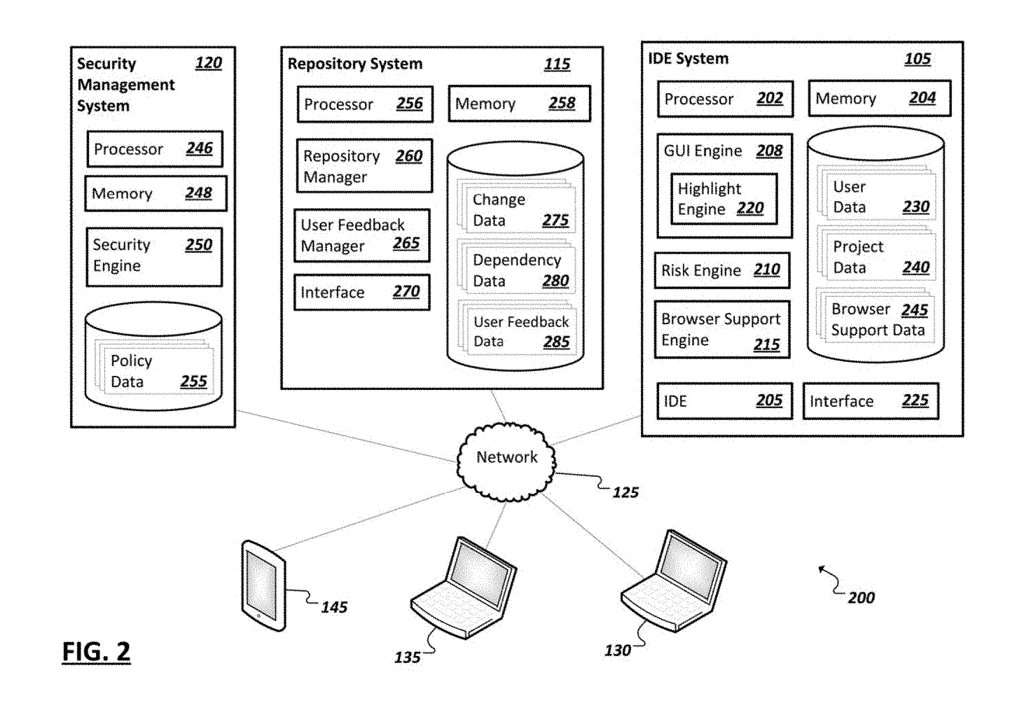

At least some of the systems described in the present disclosure, such as the systems of FIGS. 1 and 2, can include functionality to at least partially address at least some of the above-discussed issues, as well as others not explicitly described. For instance, in the example of FIG. 2, a simplified block diagram 200 is shown illustrating an example environment including an enhanced implementation of an integrated development environment (IDE) system 105. An example IDE system 105 may include one or more data processing apparatus (e.g., 202) and one or more memory elements 204 for use in implementing executable modules, such as an integrated development environment (IDE) 205, a graphical user interface (GUI) engine 208, risk engine 210, browser support engine 215, among other example components. The IDE system 105 may additional include one or more interfaces (e.g., application programming interfaces (APIs) or other interfaces), which may be used to communicate with and consume data and/or services of various outside systems, such as a repository system (e.g., 115), security system (e.g., 120), among other examples.

In one example, an IDE 205 may provide functionality such as would be included in a traditional IDE. For instance, the IDE 205 may include such facilities as a source code editor, build automation tools, a debugger, etc. and may include functionality such as code completion, object and class browsers, syntax highlighting and guides, among other example features. Additional components of the example IDE system 105 may be used to enhance the functionality of an IDE 205. For instance, as code is entered, deleted, modified, selected, or otherwise interacted with (e.g., in the source code editor), the enhanced IDE may highlight effected code within the editor or provide other visual cues to assist the developer in recognizing risk inherent in interactions and edits with various portions of the code being worked upon within the IDE. For instance, a risk engine 210 may be provided, which may determine various risk involved with various segments of code within a project or software component. Such risk may include determining varying degrees or quanta of risk, as well as various types of risk. The risk engine 210 may work in concert with a GUI engine 208 providing the GUI for the IDE 205 to implement risk-based highlighting of code associated with these determined levels of risk. For instance, a GUI engine 208 may include a highlighting engine 220, which may include logic to detect user interactions, with the IDE's GUI, with code presented in the GUI. The IDE system 105 may identify that the code which is selected, or in which a cursor has been positioned (e.g., in preparation of editing the code), corresponds to a particular segment of code, such as a particular component, method, object, function, etc. The risk engine 210 may determine risk associated with editing the particular segment of code and identify this risk to the highlight engine 210, which may cause a corresponding highlight effect to be applied to the selected code text. For instance, various colors may be applied in the highlighting, with the colors defined to communicate various information concerning the identified risk (including combinations of factors).

An IDE system 105 may maintain a variety of data, which may be utilized by the risk engine 210, highlighting engine 220, among other functionality of the IDE system 105. For instance, user data 230 may be maintained to identify various users or groups of users, which may use the IDE system 105. In some cases, the IDE system 105 may provide the enhanced IDE 205 as a service and may maintain account information for a variety of subscribers to the service in user data 230. Various policies (e.g., security policies) may be applied to projects corresponding to which user is editing the project. For instance, one of potentially many different users may utilize the IDE to edit a particular source code component offered through a shared library (e.g., in a public repository). Risks that apply to some users may not apply to other users and user data 230 may be used by the IDE system 105 to customize and selectively apply highlighting to the IDE GUI to indicate risk where appropriate (e.g., based on the user). Project data 240 may represent projects incorporating one or more source code components. Projects may define the set of components constituting a larger software development product or effort and project data 240 may identify aspects of these projects including information identifying interconnections, dependencies, and other aspects of the constituent software components.

In some implementations, software developed using IDE 205 may include web-based applications, which are designed to run on web browsers. Some web browsers may support some functions, methods, calls, and code structures, while others may not or may do so in unreliable ways. As the number of browsers and browser versions currently in use is quite large, tracking which browsers support which of the myriad possible code segments and functionality is unmanageable large and complex. Indeed, it is often the case that development teams are forced to select only a small subset of browsers to design to. A browser support engine 215 may be provided in some implementations of an IDE system 105 to identify (e.g., to the risk engine 210) lines of code, which may correspond to code structures that are incompatible or problematic in one of a set of browsers defined for the project being developed using the IDE. Accordingly, the highlighting engine 220 may highlight such instances of code relating to or defining these code structures (e.g., upon a call to a problematic method being typed into the code editor of the IDE) to identify that risk has been introduced to the successful operation of the project on one or more of the desired browsers, among other examples. To support the browser support engine 215, the IDE system 105 may maintain additional data, such as browser support data 245. Browser support data 145 may include data embodying information such as the set of selected browsers for a project, tables identifying compatibility of various code structures to various browsers and browser versions, performance information identifying how various code structure impact performance of various browsers and browser versions, among other examples.

As noted above, an example IDE system 105 may interface with various other systems and utilize information from these systems to provide the enhanced functionality, such as introduced above. For instance, an IDE system 105 may obtain information from a repository system 115 (e.g., using interfaces 225, 270), which may be used to determine risk levels associated with various code segments, which may be included in or used by various projects developed using IDE 205. In one example, a repository system 115 may include one or more data processing apparatus (e.g., 256) and one or more memory elements 258 for use in implementing executable modules, such as repository manager 260, user feedback manager 265, and other examples. An example repository manager 260 may possess functionality to define and maintain repositories to track the development and changes to various code segments or components. For instance, a repository may be developed for each of several projects, with copies of the project code being stored together with modified versions of the code and other information to track changes, including proposed, rejected, accepted, and rolled-back changes to the project. In the example shown in FIG. 2, such project change information can be embodied in change data 275. The repository system 115 can also maintain additional information regarding various projects including dependency information (e.g., in dependency data 280) to define how various projects are used and shared by and between various other projects, among other examples.

In some implementations, a repository system 115 may enable social collaboration between developers using the repository system 115. For instance, as changes to a project (or source code component) are made, they may be proposed for adoption. This may trigger a workflow, managed by the repository system 115 where other users provide feedback regarding the proposed change (e.g., facilitated through user feedback manager 265). Accordingly, feedback data (e.g., 285) may be generated to document positive and negative feedback regarding various changes, which may relate to the rejection, adoption, or rollback of changes in various projects. Such feedback data 285 may be useful as some source code components may be reused or repurposed across multiple projects and similarities between source code components may be identified, such that information in feedback data 285 may be applied to these other projects. Change data 275, dependency data 280, and user feedback data 285, and the information encapsulated therein, may be used to determine operational risk within various source code segments, components, and projects. A risk engine 210 may thus use such information as the basis of determining risk, which can cause corresponding code presented in the IDE GUI to be highlighted to indicate the risk (e.g., using highlighting engine 220), among other examples.

Continuing with the example of FIG. 2, a system may additionally include an example security management system 120. In this example, the security management system 120 may include one or more data processing apparatus (e.g., 246) and one or more memory elements 248 for use in implementing executable modules, such as security engine 250. A security management system 120 may provide functionality for detecting security vulnerabilities and threats within computing systems. In some cases, the security management system 120 may provide security services as a service to a variety of computing systems. In some implementations, a security management system 120 may maintain and enforce a variety of security policies for various computing systems. Policy data 255 may include definitions of these security policies. Policy data 255 may also define threat profiles, vulnerabilities, and other security information, which may set the foundation for security services provided by the security engine 250. For instance, some software systems may be governed by defined security policies (e.g., identified in policy data 255). For instance, specific encryption or memory protocols or modes may be required in accordance with a defined security policy, among other examples. In some cases, developer's activities coding within an IDE may potentially threaten the successful implementation and compliance with various security policies. Accordingly, security policy information included in policy data 255 may be accessed and used by a risk engine 210 to detect attempts to modify source code in a project, which may introduce security risk. Such security risk, as introduced above, may result in the IDE system highlighting portions of lines of code corresponding to the potential or real security risk, among other example uses.

It should be appreciated that the example system configuration(s) illustrated in FIG. 2 are but one example implementation. Various other alternative designs may be adopted without deviating from the general principles discussed herein. As examples, in some implementations, two or more (or all) of IDE system 105, repository system 115, and security system 120 may be implemented in a single system, combining and integrating the functionality of each within a single system. Logical and functional blocks discussed as being implemented in a particular one of the example IDE system 105, repository system 115, or security system 120 may be alternatively implemented in another one of the systems. Likewise, example data illustrated as managed in one system may be alternatively maintained and generated in another one of the example systems. As an example, project data 240 may be maintained in repository system 115 rather than in IDE system directly. In some instances, the IDE system 105 may be included in and offered in conjunction with an example repository system, among other example alternatives and implementations.

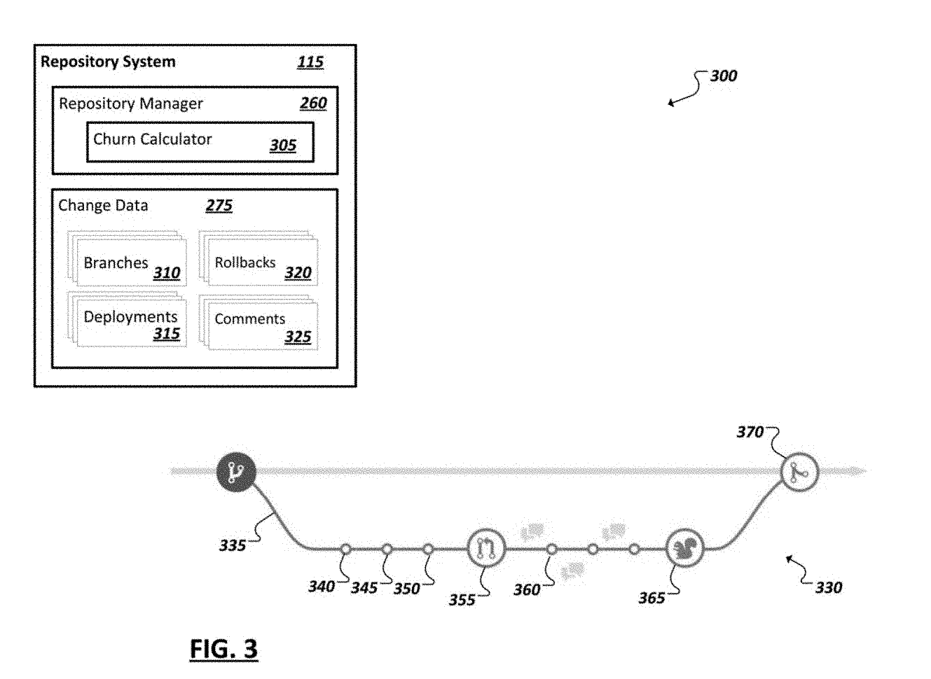

Turning to the example of FIG. 3, a simplified block diagram 300 is shown illustrating an example repository system 115. The repository system may define and manage various repositories corresponding to various projects. Some repositories can be public, in the sense that the underlying project may potentially be modified and improved upon by any interested developer. Adoption or rollback of a change may be controlled by an owner of the public repository or may be controlled democratically by the various interested users of the public repository, among other examples. Other repositories may be private and track progression of projects, which are private to a user, entity, or group of users. A repository system 115 may host an assortment of private and public repositories. Change data (e.g., 275) may be produced in connection with the maintenance of repositories (and, in some cases, defined through the repositories themselves). In one example, a repository manager 260 may include churn calculation logic (e.g., 305), which may determine the “churn” or the number of changes that take place within a given repository before changes are successfully adopted. Churn, or churn rate, may serve as metrics usable by a risk engine to determine a risk level for a project and related code. For instance, high churn may indicate that changes to a given block of code or related product are difficult to successfully implement, indicating a degree of operational risk in editing corresponding or related code.

In one example, change data may indicate a variety of information, which may be utilized to determine operational risk associated with a given piece of code. For instance, change data 275 may identify branches which have been proposed to change an associated piece of code. Deployment data 315 may identify when branches, or changes, have been adopted, and rollback data 320 may indicate when adopted changes have been later rolled back (e.g., because they proved to be detrimental changes to the code). Comments 325 may include user feedback regarding various proposed changes or branches, and may be further considered (e.g., through natural language processing and machine learning techniques) to identify types of changes or pieces of codes, which user-reviewers identify to be problematic, among other examples.

The diagram 330 presented in FIG. 3 provides an example illustration of the flow of development that may be captured in change data 275 generated through an example repository system. For instance, to pursue potential changes to a source code project, one or a number of branches may be initiated 335 for the project. “Commits” may then be made, which may be embodied as any proposed change (e.g., addition, deletion, edit) to the project. A variety of commits (e.g., 340, 345, 350) may made, with each considered a separate unit of change (e.g., to allow any one of these commit changes to be potentially rolled-back to the preceding commit). A “pull request” or “pull” (e.g., 355) may request that a collection of changes, or commits, be adopted into the project. In some cases, a pull can prompt other peer developers to evaluate the proposed change(s), which, in some embodiments, may be facilitated through social discussion or commenting features of the repository system (e.g., to generate comment data 325). Additional commits (e.g., 360) may be made (e.g., as proposed or encouraged from evaluation or comments of other users), before a request to deploy (e.g., 365) is made. A deploy request can cause final testing or validation efforts to be triggered before the changes are officially merged (e.g., 370) with the main (e.g., production version) of the project. Once merged, a record of the changes made in the merged version of the code may be memorialized in change data 275. Merged changes may (e.g., using change data recording the evolution of the code) be rolled-back to a previous version of the code (i.e., before the merge), allowing buggy or otherwise inadequate changes to code to be undone when desired. Change data 275 may capture the various aspects of the flow and evolution of a piece of code. Where changes are historically difficult to make to the code (e.g., as evidenced by a relatively large number of changes or commits, rollbacks, and critical commentary, such code may be considered operationally difficult to program. Accordingly, attempts to implement edits to these projects (or particular portions of these projects) may be identified as risky. Indeed, grades or levels of risk may be defined to identify the relative operational difficulty of some pieces of code, based on the information included in change data 275, among other example implementations.

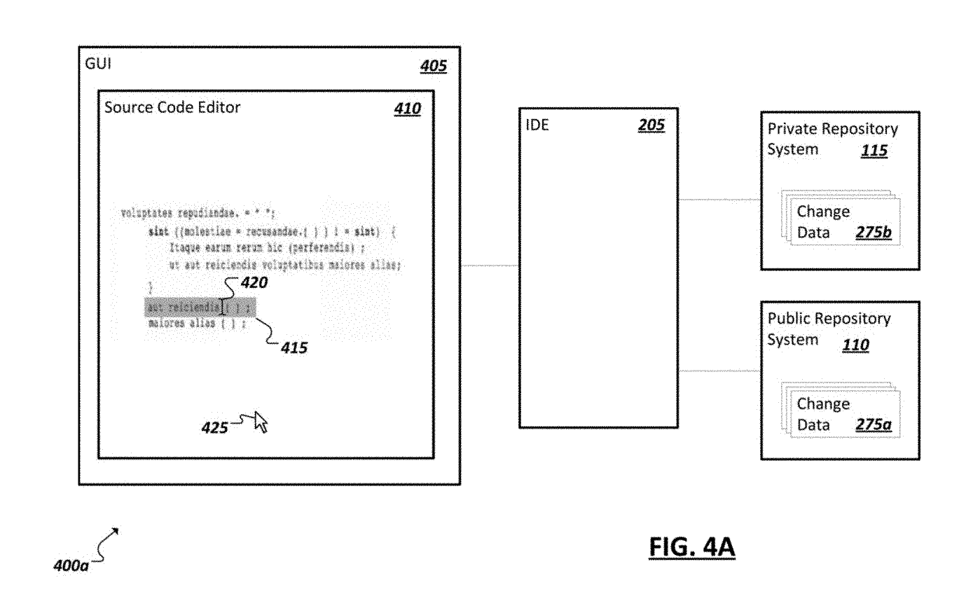

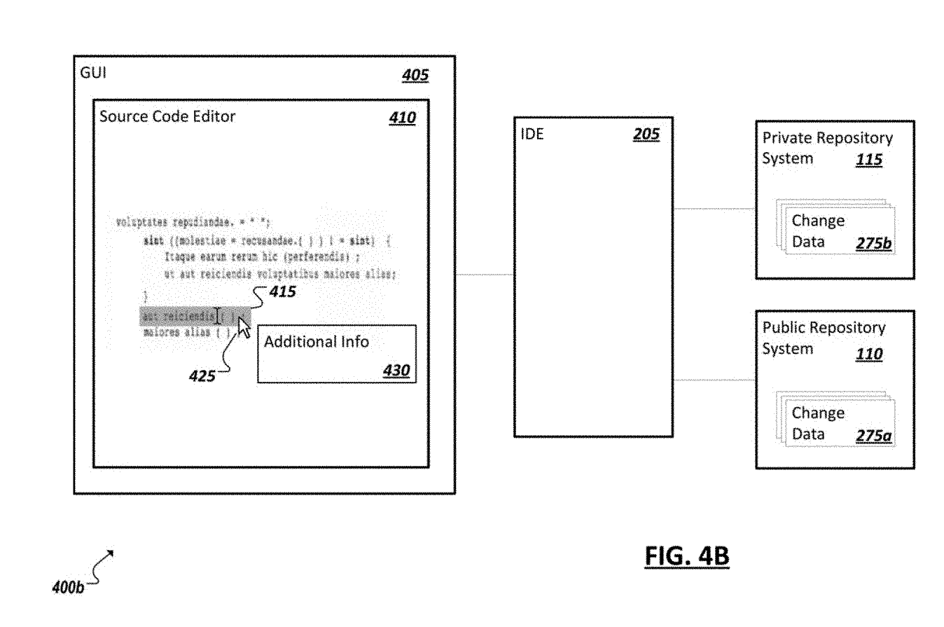

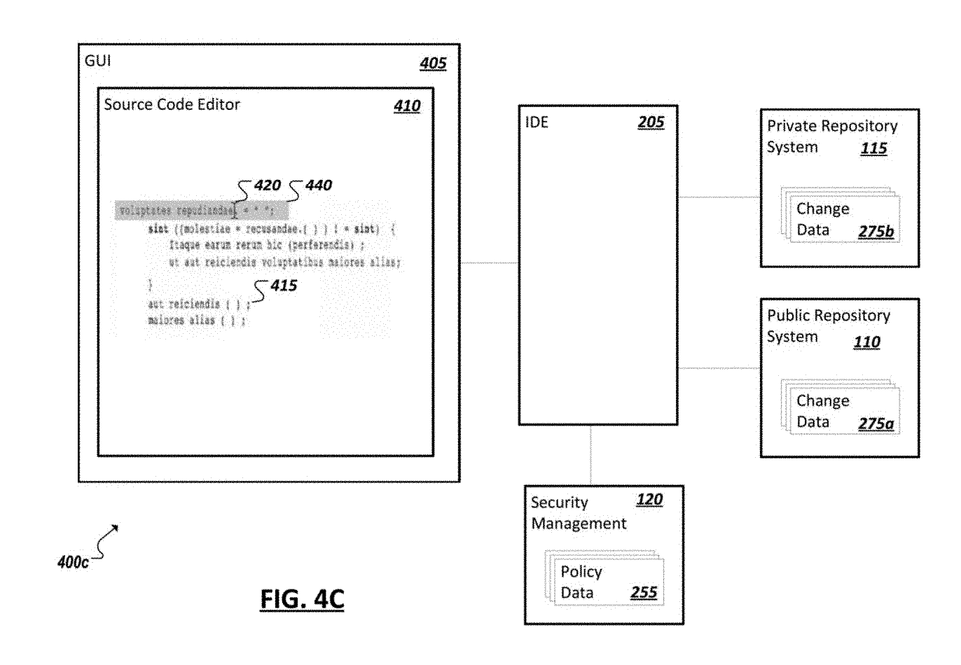

Turning to the examples of FIGS. 4A-4C, simplified block diagrams 400a-x are shown illustrating an example GUI (e.g., 405) of a development tool (e.g., an IDE 205), which is enhanced to allow certain interactions with code presented within a source code editor window 410 to be highlighted to indicate a degree of risk associated with an attempt to edit corresponding code. In the example of FIG. 4A, an enhanced IDE 205 may make use of data from public and/or private repositories, which provide change data (e.g., 275a-b) describing public and/or private changes made to a project or application. For instance, a single application may be represented by one or multiple co-referenced repositories, among other examples. Change data (e.g., 275a-b) may be utilized to determine a history of changes for each of potentially several code segments, which may be incorporated within a larger project. Accordingly, a degree of operational risk may be determined for each of the code segments in a particular project developed using the IDE 205 based on the change data (e.g., 275a-b). In this example, the IDE 205 may monitor a user's interaction with code presented in source code editor 410. The IDE may determine that a particular interaction correlates with an attempt to edit a particular line of code (e.g., 415) presented in the source code editor 410. The IDE 205 may further determine that the particular line of code (e.g., 415) corresponds to a particular source code component within the project and identify (or newly calculate) a degree of risk associated with editing lines of code associated with the particular source code component. Further, based on the identified risk and the user's interaction, the IDE may cause the particular line of code 415 to be highlighted dynamically in response to the user's interaction to indicate the identified risk. For instance, in the example of FIG. 4A, when a cursor (e.g., 420) is positioned within the particular line of code 415, the IDE may determine that the user is attempting to edit the line of code. Accordingly, upon identifying a degree of risk associated with editing the line of code, the IDE may highlight the line (e.g., while the cursor 420 is positioned on the line 415). In some cases, highlighting may only be applied to the line (or lines) of code when the corresponding risk is determined to exceed a particular threshold. The line may be highlighted with a color to indicate that the identified risk is operational (e.g., rather than security-related). The relative degree of risk may also be communicated through the color used in the highlighting. For instance, multiple risk levels may be defined (e.g., based on the relative churn rate) and corresponding highlighting colors may be assigned to communicate the level of risk, among other example features.

Turning to the example of FIG. 4B, in addition to highlighting presented code to identify corresponding risk, in some implementations, the highlighting of the code text may be further supplemented with opportunities to explore the underlying reasons behind the risk highlighting. As one example, a user may interact with the highlighting by hovering a cursor (e.g., 425) over the highlighted portion of the code (e.g., 415). In this example, hovering over the highlighting may cause an additional window 430 to be presented to indicate additional information concerning the finding that editing the code bears a certain risk. For instance, the additional information may describe the changes underlying the risk determination (e.g., as documented in change data 275a-b). In some cases, the window 430 may be selected to display still further details. For instance, a user may be presented with a description of all changes documented for the corresponding source code segment. In one example, the changes may be presented in a tree format to identify that a change was made, when it is was made, whether it was accepted, declined, or rolled back, the person or party responsible for the change among other information. The change tree may represent a “blame tree” giving the user a visualization of the various changes (and changes to changes) within the code segment, as well as providing the user with information to identify other developers who have attempted changes and navigated issues involving the code segment, among other example information and presentations.

Turning to FIG. 4C, as introduced above, risk determined by an enhanced IDE system may include not only operational risk (e.g., the risk that coding changes will be difficult to successfully implement and which may negatively impact the continued successful operation of the code), but may also include security risk. For instance, the IDE system may access and make use of security information provided by a security management system 120. For instance, various security policies may be defined (e.g., in security policy data 255), which a software system is to comply with. Changes to certain portions of the code may result in adherence to these security policies being undermined or threatened. Accordingly, the IDE may detect code segments related to these security policies and may highlight corresponding portions of the code to indicate to user-developers of the potential security risks that a change to the code could cause the corresponding project or software system to run afoul of the security policies. For instance, in the example of FIG. 4C, a user may move a text cursor 420, or caret, from one portion of the code to another (e.g., using arrow keys, a mouse, voice commands, touch commands, gesture commands, or other user interface), causing another portion of the code to be ready for editing in a source code editor 410. In one example, when the active text cursor is removed from a previously highlighted line (e.g., 415), the highlighting may also be made to disappear (as is illustrated in the example of FIG. 4C) and the IDE 205 may assess whether the new position of the text cursor corresponds to another (or even the same previously highlighted) risk that warrants a highlight to warn the user. In the example of FIG. 4C, the text cursor 420 is repositioned in line 440 of the code. In this example, a security risk is identified, which corresponds to the line 440 and the line (or the relevant portion of the line) is highlighted to identify the risk. In some cases, risk determined for a segment of code that includes a degree of security risk may be highlighted differently (e.g., in a different color) than risk that is purely operational. In some cases, identified risk corresponding to a code segment may be a mixture of both operational and security risk (and as such may be highlighted in a predefined color to indicate the same), among other example implementations and features. As with the example of FIG. 4B, code highlighting based on security risk may also be interactive through the GUI 405 to allow additional information to be presented to the user regarding the basis of the determined security risk so as to allow the user to assess how to more specifically navigate the presented risk, among other example considerations.

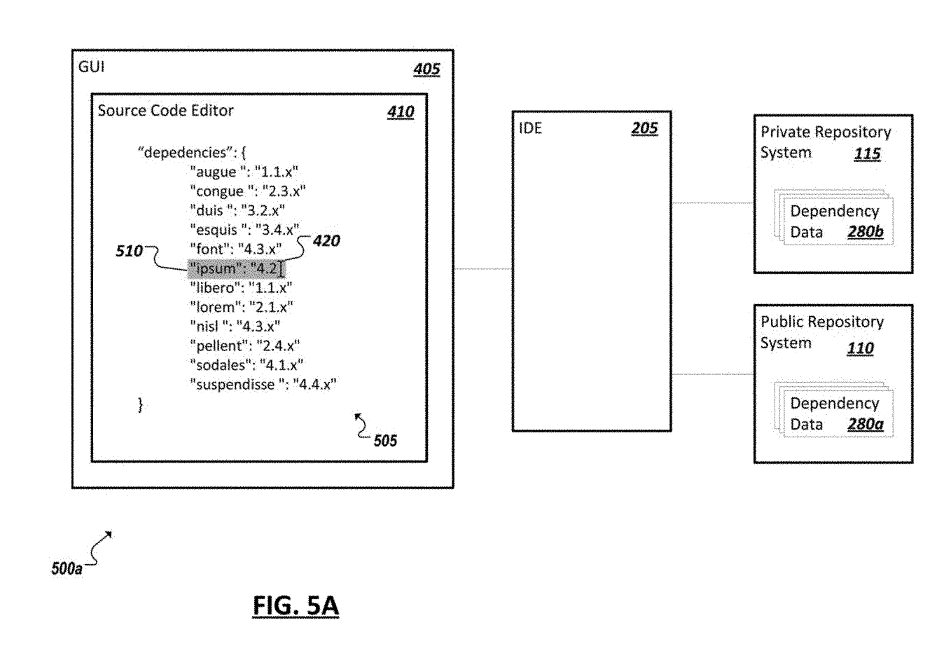

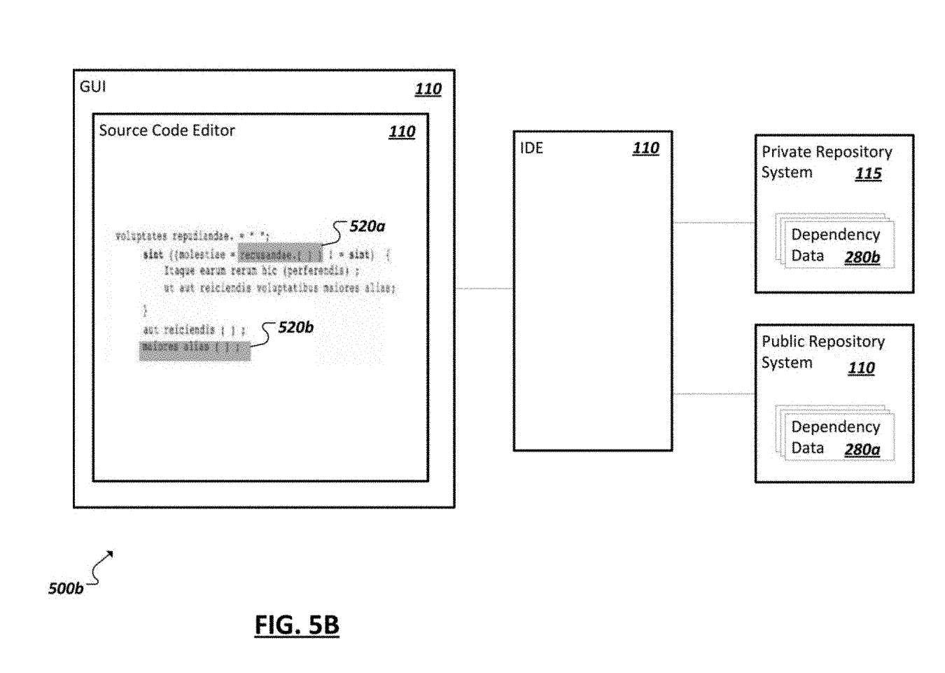

In some cases, software coding projects may make use of other code components, including third-party components and components obtained through shared repositories, among other examples. Such dependencies may be defined within a code project and may be updated using the source code editor 410 of an IDE 205. As versions of these dependencies change, it may be desirable for a developer to update their dependency to the latest version. However, in some cases, changes within the version update of the dependency may not be compatible with or threaten the successful operation and integration of this code within the larger project. For instance, an update within a dependency may represent “breaking changes” to one or more methods, objects, or other functionality inherited through the dependency. In some implementations, such as illustrated in the simplified block diagrams 500a-b of FIGS. 5A-5B, dependency data (e.g., 280a-b) maintained by a repository (e.g., 110, 115) may describe changes between versions of a dependency and may identify whether and how these changes are either breaking or non-breaking changes. Accordingly, in the case of breaking changes, updating a project's dependency to incorporate an updated version of the dependent code component may present a risk to the project. As an example, shown in FIG. 5A, when a user positions a cursor (e.g., a text cursor 420) to attempt to change a particular dependency defined in a line of code 510 (e.g., within dependency definitions 505), the line of code 510 may be highlighted to indicate the risk. This risk may be based not only on identifying that breaking changes exist for certain method calls and other features within the dependency, but also based upon identifying that these breaking changes affect the project under development. For instance, an update to a dependency may “break” previous version of a method offered through the dependency, but keep others unbroken. Accordingly, whether the update presents a risk in the immediate project (e.g., being edited using the IDE 205), may be based on detecting that the broken methods (or other code) of the dependency are actually used within the project.

Turning to the example of FIG. 5B, in a situation where an updated dependency is accepted and integrated within a project (e.g., by editing dependency definitions 505), a highlighting engine of the IDE may identify instances throughout the project where the updated dependency introduces the threat of breaking changes within the project. For instance, as illustrated in FIG. 5B, lines of project code (e.g., 520a-b) that reference, use, or rely on results of various broken methods, variables, objects, or other segments of the dependency code may be highlighted to allow a user to identify the effect of the update, among other example features.

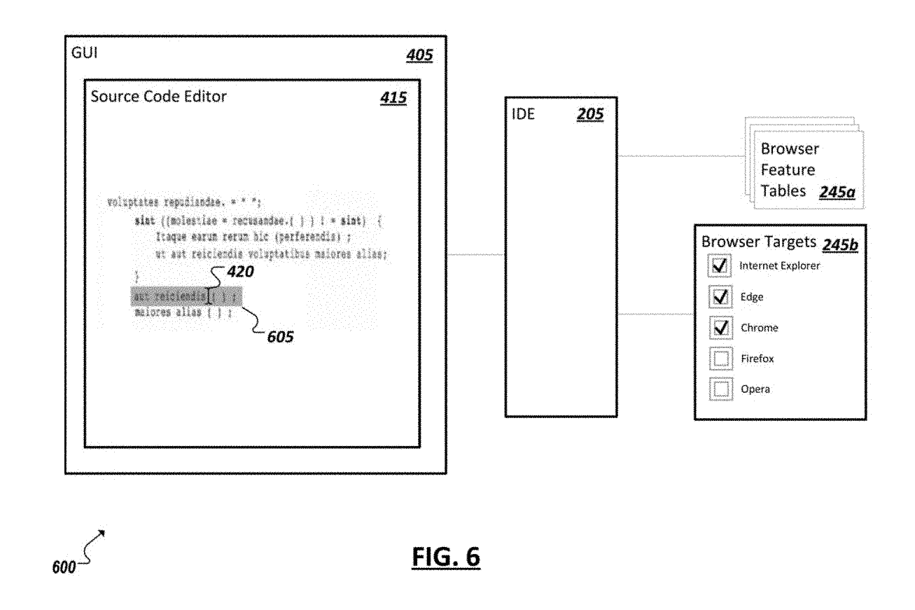

Turning to the simplified block diagram 600 in the example of FIG. 6, some software projects may be intended to run (e.g., as web-based applications or services) on a particular deployment target. As an example, a software project may be intended to be run within a web browser and multiple different web browser programs may be targeted as deployment targets for the project. An IDE 205 enhanced with risk highlighting functionality, such as discussed herein, may be provided to identify risk associated with introducing code, which may be incompatible with or sub-optimally supported by particular deployment targets for which the code is being developed. For instance, browser target data 245b may be provided with a project-specific definition to identify a subset of the potentially may browsers and browser versions, which a developer wishes to tailor their project toward. Further, browser support table data 245a may also be accessed, which sets forth, on a browser-by-browser basis, whether and to what extent each browser supports various code elements (e.g., various JavaScript functions, etc.). Accordingly, a risk engine of an IDE system may utilize this browser support data (e.g., 245a-b) to identify instances where a user attempts to introduce or change code elements, which may present a risk to the goal of having the production version of the project be compatible with the desired set of browsers (e.g., identified in browser target data 245b). It should be appreciated that similar target data may be provided for other non-web browser-type deployment targets, and may similarly identify whether various deployment targets support various features, code elements, and features, such that an enhanced IDE may dynamically identify risks (e.g., through highlighting) associated with code developed using the IDE based on this target data.

Continuing with the example of FIG. 6, an IDE may detect interactions or changes to code made by a user, which introduce or use code, which may negatively impact performance or introduce incompatibilities with one or more of the browsers selected for the project. Accordingly, a risk may be determined corresponding to these interactions (e.g., through the positioning of a text source code editor 415), and the corresponding code (e.g., 605) may be highlighted to indicate the determined risk to operation within one or more of the selected, desired browsers. In some cases, the highlighting may be formatted to indicate which browser (or combination of browsers) would be affected by the highlighted code, among other examples. In some cases, browser feature table data or other browser support data may indicate not only whether code may negatively impact operation of the corresponding program within a given set of browsers, but may also identify known performance consequences to including certain code structures within the program. In some cases, performance targets may be defined for a project and the IDE may possess logic to detect the inclusion of various code structures, which have known performance impacts. In some implementations, a highlighting engine of the IDE 205 may highlight instances of code pertaining to these code structures where it is determined that the predicted performance impact of the code structure threatens a specifying performance target for the program's operation (e.g., its load time, execution latency, etc.). For instance, where a performance impact for a particular performance metric exceeds a threshold percentage of the overall allowance for the performance metric, corresponding code (e.g., 605) may be highlighted to identify, to the user, the risk that inclusion of this code poses to the performance targets set for the corresponding software component being developed using the IDE, among other example implementations.

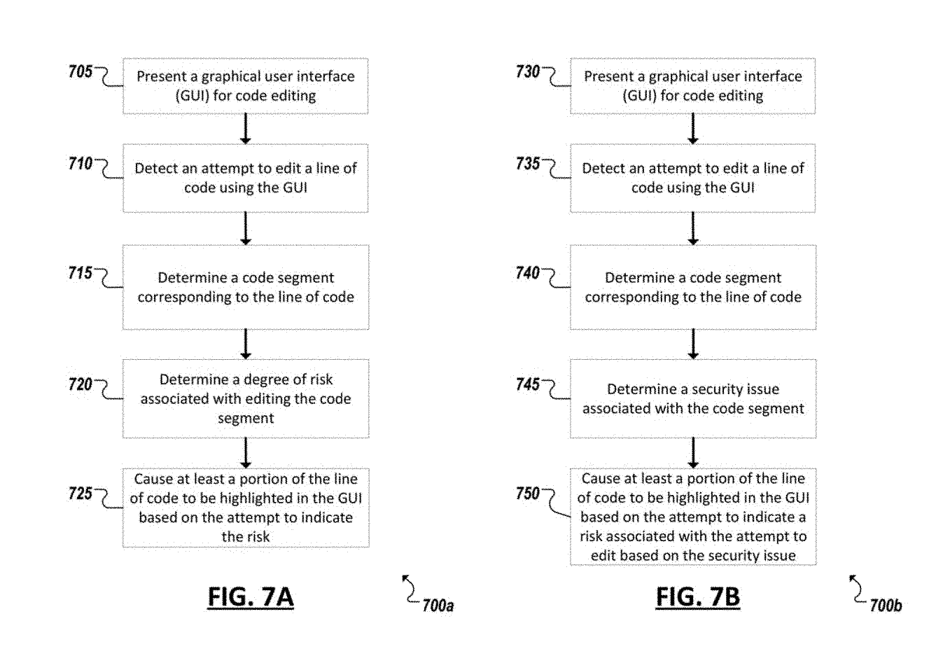

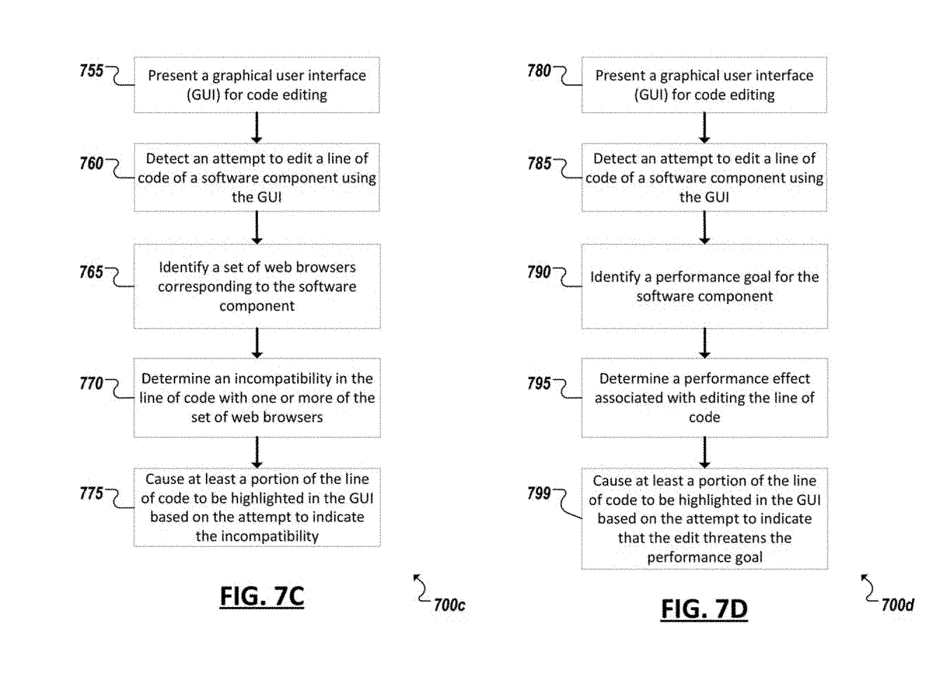

Turning to FIGS. 7A-7D, simplified flowcharts 700a-d are presented illustrating example techniques for providing risk highlighting within a source code editor of a software development program, such as an IDE. For instance, turning to the example of FIG. 7A, a graphical user interface (GUI) may be presented 705 in a display of a computing device, the GUI including a source code editor. An attempt to edit a line of code may be detected 710 based on an interaction of a user with the GUI, such as the placement of a text cursor in the line of code, among other example interactions. A particular code segment (e.g., of a larger project or program) may be determined 715 to correspond to the line of code. The code segment may include the line of code itself, the line of code may reference or call the code segment, among other example correlations between the line of code and the particular code segment. A degree of risk may be determined 720 to be associated with the particular code segment. The degree of risk may be based on a number of attempted changes made to the particular code segment (e.g., which may be documented in change data generated and maintained by in a repository corresponding to the particular code segment). Based on the degree of risk (e.g., whether is exceeds a threshold level of risk), at least a portion of the line of code may be automatically highlighted within the GUI in response to the user's interaction with the line of code to indicate the degree of risk determined. The degree of risk may pertain to the risk involved in editing the line of code, either or both from the perspective of operational or security risk, among other example risk.

In the example of FIG. 7B, a graphical user interface (GUI) may be presented 730 in a display of a computing device, the GUI including a source code editor. An attempt to edit a line of code may be detected 735 based on an interaction of a user with the GUI. A particular code segment (e.g., of a larger project or program) may be determined 740 to correspond to the line of code. In this example, a security issue may be determined 745 that is associated with the particular code segment, such as the code segment's pertinence to the fulfilling of one or more security policies set for the project, application, or system of which the code segment is a part, among other example security issues. Based on the security risk, at least a portion of the line of code may be automatically highlighted within the GUI to identify the security risk to a user, such that the user appreciates the potential security risk present in editing the highlighted code.

In the example of FIG. 7C, a graphical user interface (GUI) may be presented 755 in a display of a computing device, the GUI including a source code editor. An attempt to edit a line of code may be detected 760 based on an interaction of a user with the GUI. Data identifying a set of target web browsers may be accessed to identify 765 that the set of web browsers correspond to the software component being edited using the source code editor. The attempt to edit the line of code may be determined 770 to potentially introduce an incompatibility with one or more of the set of web browsers (e.g., based on one or more browser feature tables). These incompatibilities may introduce risk to the operability goals for the software component and at least a portion of the line of code may be automatically highlighted within the GUI to identify this risk to the user and provide the user with an opportunity to determine whether they would like to proceed or consider an alternative solution for the code.

In the example of FIG. 7D, a graphical user interface (GUI) may be presented 780 in a display of a computing device, the GUI including a source code editor. An attempt to edit a line of code may be detected 785 based on an interaction of a user with the GUI. In this example, performance goals may be predefined for the software component of which the source code is a part. These performance goals may be identified 790 and considered by the source code editing system (e.g., as implemented in an enhanced IDE system). Further, data may be accessed and processed by the system to determine 795 potential performance effects of various code segments within the code. As these code segments are added, deleted, or modified (e.g., using the source code editor), these changes may result in changes to the predicted performance profile for the code. Accordingly, the attempt to edit the line of code may be determined to potentially impact the performance profile of the overall code and at least a portion of the line of code may be automatically highlighted within the GUI to identify that a risk is present in the editing of the code as it pertains to the project meeting its defined performance targets. This may allow the user to consider trade-offs if the edit is unavoidable such that other modification may be made to allow the performance targets to still be met in spite of the edit, among other considerations and examples.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
detecting placement of a cursor within a line of code presented in a source code editor window of a graphical user interface (GUI) of an integrated development environment (IDE);
determining a particular segment of code within a software program corresponding to the line of code;
determining, from data comprising a repository of code changes relating to the particular segment of code, a level of risk associated with the particular segment of code, wherein the level of risk indicates a likelihood that changes to source code of the software program relating to the particular segment of code will jeopardize successful operation of the software program; and
causing at least a portion of the line of code to be automatically highlighted within the source code editor window based on the level of risk and responsive to the placement of the cursor within the line of code.

2. The method of claim 1, wherein the repository of code changes indicates a number of changes made to the particular segment of code, the level of risk corresponds to the number of changes, and a higher number of changes corresponds to a higher level of risk.

3. The method of claim 2, wherein the repository of code changes further indicates whether changes in the number of changes were rejected or rolled-back, and the level of risk is further based on whether the changes were rejected or rolled-back.

4. The method of claim 3, wherein a higher number of changes that were rejected or rolled-back corresponds to a higher level of operability risk.

5. The method of claim 1, wherein the portion of the line of code is highlighted in a color corresponding to the determined level of risk.

6. The method of claim 5, wherein the color corresponds to a type of risk.

7. The method of claim 6, wherein the type of risk comprises one of a security risk, an operability risk, or a risk that the project will be incompatible with a particular browser.

8. The method of claim 1, further comprising:
detecting a cursor manipulated to hover over the highlighted portion of the line of code; and
presenting information in the graphical user interface to correspond to the cursor hovering over the highlighted portion of the line of code, wherein the information describes details of the determination of the level of risk.

9. The method of claim 8, wherein the information identifies a number of previous changes to the particular segment of code, and the level of risk is based on the number of previous changes to the particular segment of code.

10. The method of claim 1, wherein the data further comprises security policy data, and the level of risk is further based on whether the particular segment of code presents a security risk in the software program based on one or more security policies identified in the security policy data.

11. The method of claim 1, further comprising:
identifying a subset of a plurality of web browsers designated as corresponding to the software program, wherein the level of risk is based on whether the particular segment of code threatens compatibility of the software program with the subset of web browsers.

12. The method of claim 1, further comprising:
identifying one or more target performance metrics for the software program; and
determining, from the data, a predicted performance effect attributable to inclusion of the particular segment of code in the source code of the software program, wherein the level of risk is based on a degree to which the predicted performance effect jeopardizes meeting the performance metrics.

13. The method of claim 1, wherein the placement of the cursor corresponds to entry of text in the line of code.

14. The method of claim 13, wherein highlighting of the portion of the line of code is removed when the cursor is moved from the line of code.

15. The method of claim 1, wherein the particular segment of code originates from a shared library of code.

16. The method of claim 15, wherein the repository comprises a public repository.

17. A non-transitory computer readable medium having program instructions stored therein, wherein the program instructions are executable by a computer system to perform operations comprising:
detecting an attempt to edit a line of source code of a particular software program in an integrated development environment;
determining that the line of the source code corresponds to a particular segment of code;
determining a degree of risk corresponding to the attempt to edit based at least in part on a number of changes identified for the particular segment of code in a repository of code changes; and
causing at least a portion of line of code to be automatically highlighted in a graphical user interface of the integrated development environment to indicate the determined degree of risk while a cursor is positioned to correspond to the line of source code in the graphical user interface.

18. A system comprising:
a data processing apparatus;
a memory; and
an integrated development environment, executable by the data processing apparatus to:
present a graphical user interface comprises a source code editing window;
detect an attempt to edit a line of source code of a particular software program in an integrated development environment;
determine that the line of the source code corresponds to a particular segment of code;
determine a degree of risk corresponding to the attempt to edit based at least in part on a number of changes identified for the particular segment of code in a repository of code changes; and
cause at least a portion of line of code to be automatically highlighted in a graphical user interface of the integrated development environment to indicate the determined degree of risk while a cursor is positioned to correspond to the line of source code in the graphical user interface.

19. The system of claim 18, further comprising a repository system, wherein the repository system maintains the repository.

20. The system of claim 19, wherein the repository comprises a public repository and at least some of the changes originate from organizations separate from an organization designated as an owner of the particular segment of code.
